(19) United States
(12) Patent Application Publication
(10) Pub. No.: US 2022/0180764 A1
(43) Pub. Date: Jun. 9, 2022

(54) METHOD AND SYSTEM FOR GENERATING A TRAINING PLATFORM

(71) Applicant: THE ROYAL INSTITUTION FOR THE ADVANCEMENT OF LEARNING / MCGILL UNIVERSITY, Montreal (CA)

(72) Inventors: Nykan MIRCHI, Beaconsfield (CA); Nicole LEDWOS, Oakville (CA); Vincent BISSONNETTE, Montreal (CA); Alex WINKLER SCHWARTZ, Montreal (CA); Recai YILMAZ, Montreal (CA); Rolando DEL MAESTRO, Tiverton (CA)

(21) Appl. No.: 17/438,118

(22) PCT Filed: Mar. 20, 2020
(86) PCT No.: PCT/CA2020/050353

§ 371 Date: Sep. 10, 2021

Related U.S. Application Data
(60) Provisional application No. 62/821,091, filed on Mar. 20, 2019.

(51) Int. Cl. G09B 9/00; G09B 5/06

(52) U.S. Cl. CPC G09B 9/00; G09B 5/065

(57) ABSTRACT

Systems and methods for generating a training platform are described herein. The method comprises acquiring data indicative of users interacting with a simulated scenario; generating, from the acquired data, a plurality of metrics for evaluating performance of tasks within the simulated scenario; generating a model based on the acquired data and the plurality of metrics, the model corresponding to a sum of components comprising the plurality of metrics and associated weights; assigning competencies to one or more of the components of the model, the competencies corresponding to aspects of the simulated scenario having at least two performance levels associated thereto; and generating, from the model and the simulated scenario, the training platform for evaluating performance by selecting one of the at least two performance levels for the competencies.

### CROSS-REFERENCE TO RELATED APPLICATIONS

The present application claims the benefit of U.S. Provisional Patent Application No. 62/821,091 filed on Mar. 20, 2019, the contents of which are hereby incorporated by reference.

### TECHNICAL FIELD

The present disclosure relates generally to simulators used for training, and, more particularly, to creating and/or generating a training platform.

### BACKGROUND OF THE ART

Computer-based simulation training is increasingly being used in various fields and industries. A user of a computer-based simulator interacts with the simulation to perform one or more actions of a simulated scenario. The user's actions can be processed to evaluate the user's ability to perform the required tasks. Given the growing number of fields to which computer-based simulation training is applicable, and the importance of properly evaluating the various skills of users in training, there is a need for improvement.

### SUMMARY

In accordance with a first broad aspect, there is provided a method for generating a training platform. The method comprises acquiring data indicative of users interacting with a simulated scenario; generating, from the acquired data, a plurality of metrics for evaluating performance of tasks within the simulated scenario; generating a model based on the acquired data and the plurality of metrics, the model corresponding to a sum of components comprising the plurality of metrics and associated weights; assigning competencies to one or more of the components of the model, the competencies corresponding to aspects of the simulated scenario having at least two performance levels associated thereto; and generating, from the model and the simulated scenario, the training platform for evaluating performance by selecting one of the at least two performance levels for the competencies.

In some embodiments of the method, the method further comprises selecting a subset of metrics from the plurality of metrics based on an ability to differentiate between two or more classes, and wherein generating the model comprises generating the model based on the subset of metrics.

In some embodiments of the method, the model is represented by:

h(x)=θ₀+θ₁x₁+θ₂x₂+ . . . +θₙxₙ

where h(x) corresponds to a hypothesis, θᵢ corresponds to an i-th weight associated with an i-th metric xᵢ, θᵢxᵢ corresponds to an i-th component, and where θ₀ corresponds to a bias assignable to zero.

In some embodiments of the method, components are grouped into common competencies based on parameters associated with at least one of the metrics and the weights.

In some embodiments of the method, the training platform outputs an overall performance level based on the sum of the components and at least one competency-related performance level based on at least one of the components.

In some embodiments of the method, the competency-related performance level is displayed to show performance levels of individual metrics associated with a corresponding competency.

In some embodiments of the method, the training platform tests the competencies in a multi-step scenario, wherein a given step is presented when a predetermined performance level is achieved on a previous step.

In some embodiments of the method, the acquired data comprises measurements associated with a control device operated by a user while performing tasks within the simulated scenario.

In some embodiments of the method, the measurements comprise at least one of positional measurements, rotational measurements, and force measurements associated with the control device.

In some embodiments of the method, the control device is a surgical tool and the simulated scenario is a surgical task.

In accordance with another broad aspect, there is provided a system for generating a training platform. The system comprises at least one processing unit and a non-transitory computer-readable memory having stored thereon program instructions. The program instructions are executable by the at least one processing unit for acquiring data indicative of users interacting with a simulated scenario; generating, from the acquired data, a plurality of metrics for evaluating performance of tasks within the simulated scenario; generating a model based on the acquired data and the plurality of metrics, the model corresponding to a sum of components comprising the plurality of metrics and associated weights; assigning competencies to one or more of the components of the model, the competencies corresponding to aspects of the simulated scenario having at least two performance levels associated thereto; and generating, from the model and the simulated scenario, the training platform for evaluating performance by selecting one of the at least two performance levels for the competencies.

In some embodiments of the system, the program instructions are further executable for selecting a subset of metrics from the plurality of metrics based on an ability to differentiate between two or more classes, and wherein generating the model comprises generating the model based on the subset of metrics.

In some embodiments of the system, the model is represented by:

h(x)=θ₀+θ₁x₁+θ₂x₂+ . . . +θₙxₙ

where h(x) corresponds to a hypothesis, θᵢ corresponds to an i-th weight associated with an i-th metric xᵢ, θᵢxᵢ corresponds to an i-th component, and where θ₀ corresponds to a bias assignable to zero.

In some embodiments of the system, components are grouped into common competencies based on parameters associated with at least one of the metrics and the weights.

In some embodiments of the system, the training platform outputs an overall performance level based on the sum of the components and at least one competency-related performance level based on at least one of the components.

In some embodiments of the system, the competency-related performance level is displayed to show performance levels of individual metrics associated with a corresponding competency.

In some embodiments of the system, the training platform tests the competencies in a multi-step scenario, wherein a given step is presented when a predetermined performance level is achieved on a previous step.

In some embodiments of the system, the acquired data comprises measurements associated with a control device operated by a user while performing tasks within the simulated scenario.

In some embodiments of the system, the measurements comprise at least one of positional measurements, rotational measurements, and force measurements associated with the control device.

In some embodiments of the system, the control device is a surgical tool and the simulated scenario is a surgical task.

Any of the above features may be used together, in any combination.

### DESCRIPTION OF THE DRAWINGS

Reference is now made to the accompanying figures in which:

FIG. 1 is a diagram of an example simulation system, in accordance with one or more embodiments;

FIG. 2 is a diagram of an example framework for a training platform, in accordance with one or more embodiments;

FIG. 3 is a flowchart illustrating an example method for generating a training platform, in accordance with one or more embodiments;

FIG. 4 is a plot of a sigmoid function, in accordance with one or more embodiments;

FIGS. 5A, 5B and 5C are diagrams of example outputs of the training platform, in accordance with one or more embodiments; and

FIG. 6 is a schematic diagram of an example computing system for implementing the method of FIG. 3, in accordance with one or more embodiments.

It will be noted that throughout the appended drawings, like features are identified by like reference numerals.

### DETAILED DESCRIPTION

There are described herein methods and systems for generating a training platform that may be used for any suitable domain or field. The training platform uses one or more simulated scenarios to train a user. A simulated scenario corresponds to a virtual simulation of a situation that the user may encounter in the real world. The training platform evaluates the user's performance of a task within the simulated scenario and provides an evaluation of the user's overall competency. Detailed insights of the user's performance within the simulated scenario may also be obtained.

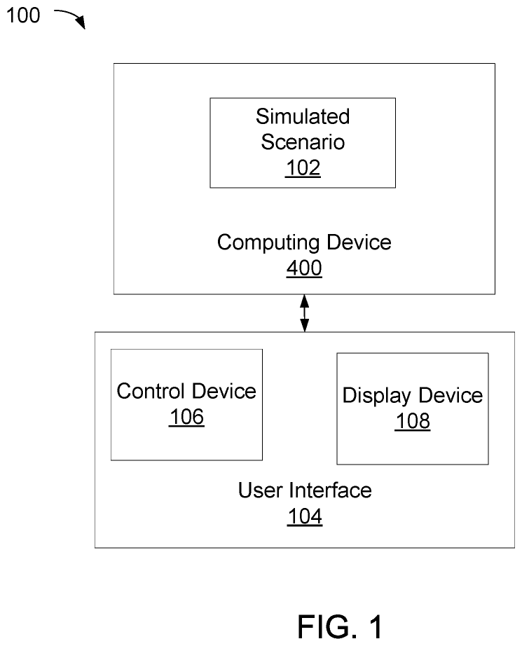

FIG. 1 illustrates an example of a simulation system 100, in accordance with some embodiments. The system 100 provides a simulated scenario 102 via a computing device 400. The simulated scenario 102 comprises a virtual environment and at least one task to be completed in the virtual environment. A user performs one or more actions in the virtual environment to complete the task. For example, the simulated scenario 102 may be of a medical procedure. Accordingly, the system 100 may be a medical or surgical simulation system. By way of another example, the simulated scenario 102 may be of a driving course. Accordingly, the system 100 may be a driving simulator.

In some embodiments, the system 100 may be a virtual reality system, whereby the user is immersed in the virtual world and experiences various sensory feedbacks. The computing device 400 implements an application for providing the simulated scenario 102 that the user interacts with via a user interface 104. The user interface 104 comprises at least one control device 106 and at least one display device 108 for the user to interact with the simulated scenario 102. For example, the control device 106 may be a medical tool that is used during a medical procedure and virtual reality images are displayed on the display device 108. In another example, the control device 106 may comprise a steering wheel, an accelerator and a break, and a driving course is displayed on the display device 108. The display device 108 may be a display screen, a 3-dimensional headset/goggles or any other suitable visual interface. As the control device 106 is moved by the user, a graphical representation of the control device 106 may correspondingly move within a graphical environment of the simulated scenario 102 on the display device 108. The control device 106 may comprise one or more sensors for monitoring the movement of the control device 106. In some embodiments, one or more sensors external to the control device 106 may be used for monitoring movement of the control device 106. The computing device 400 may be configured to record the measurements from the sensors and/or the user's interactions with the simulated scenario 102. The simulation system 100 may vary depending on practical implementations.

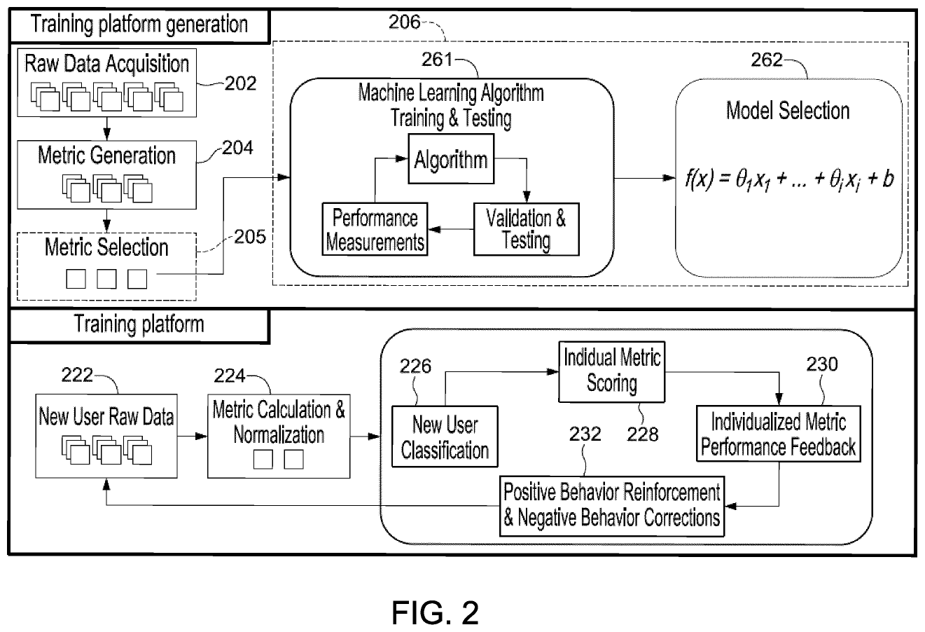

With reference to FIG. 2, there is shown an example framework for the training platform. The framework illustrates the generation of the training platform and the training platform in use. The upper section of FIG. 2 illustrates the process for generating the training platform, in accordance with some embodiments. At 202, data indicative of a plurality of users interacting with the simulated scenario 102 is acquired. At 204, a plurality of metrics for the simulated scenario 102 are generated from the acquired data. Optionally at 205, algorithms or statistical methods are used to select metrics. For example, a selection may be made based on the metrics' abilities to differentiate between two or more classes (i.e. levels of performance).

At 206, a model is generated based on the acquired data and the plurality of metrics. In some embodiments, generating the model comprises, at 261, providing the selected metrics to one or more machine learning algorithms for training, testing, and generating a plurality of models, and at 262, selecting a final predictive model from the plurality of models based on predictive performance, such as but not limited to accuracy, sensitivity, and/or specificity.

The lower section of FIG. 2 illustrates the use of the training platform by a new participant, which is described in further detail below.

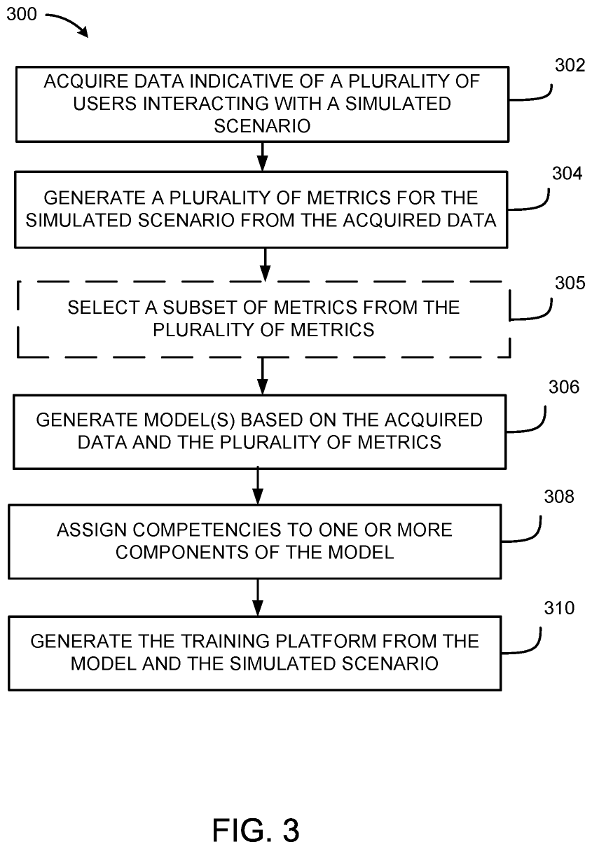

With reference to FIG. 3, there is shown a flowchart illustrating an example method 300 for generating a training platform. The method 300 may be implemented by the computing device 400 and/or a separate computing device. At step 302, data indicative of a plurality of users interacting with the simulated scenario 102 is acquired. The acquired data corresponds to how each user interacts with the simulated scenario 102. In some embodiments, the acquired data corresponds to the user performing tasks within the simulated scenario on a simulation system, such as simulation system 100. In some embodiments, part or all of the acquired data results from the simulation of a user performing one or more actions to complete the task of the simulated scenario.

The acquired data may comprise one or more measurements of the control device 106. In some embodiments, the acquired data comprises one or more of positional measurements of the control device 106, rotational measurements of the control device 106, and force measurements of (or on) the control device 106. Depending on the specific implementations, the measurements of the control device 106 may be tailored. Accordingly, position, rotation, and force are only examples. In the case of a surgical procedure, the positional and rotational measurements may be as applied to a surgical tool. The force measurements may relate to the forces applied to an anatomical structure. Additional measurements, such as volume measurements of removed anatomical structures may also be provided. The acquired data may comprise data produced from the simulation system 100 corresponding to one or more events that occurred in the simulated scenario 102. In some embodiments, the simulation system 100 produces data indicative of the start of a patient complication and, if applicable, the end of the complication. For example, if a patient begins to flat-line in the simulated scenario 102, this may be recorded as an event and data representative of the event may be acquired. The data may be acquired by recording each user's interactions with the simulated scenario 102, recording the occurrence of events in the simulated scenario 102, and storing the acquired data to one or more databases. When the acquired data is needed, the data may be retrieved from the one or more databases.

At step 304, a plurality of metrics for the simulated scenario 102 are generated from the acquired data. Each metric corresponds to a measure for evaluating the performance of the simulated scenario 102. The metrics may be generated in various manners. In some embodiments, metrics representative of measures of performance may be determined by experts in the field of the simulated scenario 102. In the surgical field, for example, expert surgeons may be consulted to choose metrics that they believe reflect surgical performance in a given surgical task. Accordingly, the metrics may be metrics of surgical performance. In some embodiments, metrics identified from previous studies and/or simulation may be used. In some embodiments, metrics allowing distinction of skill level may be generated from the acquired data. The computing device 400 may extract information from the acquired data to generate the metrics. This may include extracting information relating to the use of the control device 106. For example, in the context of surgery, instrument force application by a trainee is difficult to assess by the surgeon instructor. However, the computing device 400 may extract information regarding the use of the surgical tool. For instance, position and forces of the surgical tool may be extracted and may be used to create metrics to measure surgical performance. Other types of measurements of the surgical tool for creating metrics to assess surgical performance are contemplated. Accordingly, the computing device 400 may assign one or more actions performed to complete the task of the simulated scenario 102 to a corresponding metric.

In some embodiments, at step 305, a subset of metrics is selected from the initial metrics generated at step 304. The subset of metrics may be selected based on the ability to differentiate between two or more classes using the given metric. The subset of metrics may correspond to ones from the initial metrics that are suitable for a machine learning algorithm to distinguish between two or more classes. In some embodiments, the classes are two or more performance levels of a user. For example, the performance levels may be one of expert/novice, pass/fail, and the like. By way of another example, the performance levels may be medical student, resident, fellow, consultant surgeon. The performance levels may vary depending on practical implementations.

Several techniques can be used for selecting the subset of metrics. In some embodiments, algorithmic methods are used to select the subset of metrics. For example, forward or backward feature selection may be used. Forward feature selection involves an iterative process whereby metrics are added one by one and the algorithm's predictive performance is tested for each iteration. The final metric subset is defined as the subset with the highest accuracy. Backward feature selection, on the other hand, starts with all the metrics, and gradually removes one metric at a time while testing an algorithm's performance. Again, the optimal subset of metrics is defined by the point where the highest accuracy is reached. However, as feature selection is a continuously evolving field of research, novel machine learning literature may be consulted to learn more about which selection technique would be ideal for different simulation scenarios. In some embodiments, non-algorithmic methods are used to select the subset of metrics. For example, expert-based selection may be used for selecting the subset of metrics. That is, an expert in the field may select the subset of metrics to be used. Other techniques for selecting the subset of metrics may be used.

At step 306, a model is generated based on the acquired data and the plurality of metrics generated at step 304. In some embodiments, the model is generated using the subset of metrics selected at step 305. The model corresponds to a sum of a plurality of components, each component comprising a metric from the plurality of metrics and an associated weight. The model may be represented by:

h(x)=θ₀+θ₁x₁+θ₂x₂+ . . . +θₙxₙ (1)

where h(x) corresponds to a hypothesis, θᵢ corresponds to the i-th weight associated with the i-th metric xᵢ, and θᵢxᵢ corresponds to the i-th component. In some embodiments, as shown in equation (1), the first weight θ₀ does not have an assigned metric and therefore corresponds to a bias. In some embodiments, the model does not have a bias or the bias is zero. The plurality of weights may be represented by the following column vector:

$$θ = [ \begin{matrix}{θ}_{0} \\ {θ}_{1} \\ {θ}_{2} \\ ⋮ \\ {θ}_{n}\end{matrix} ] , \qquad ( 2 )$$

and the plurality of metrics may be represented by the following column vector:

$$x = [ \begin{matrix}{x}_{o} \\ {x}_{1} \\ {x}_{2} \\ ⋮ \\ {x}_{n}\end{matrix} ] . \qquad ( 3 )$$

Accordingly, the model may be represented by:

$$h ( x ) = [ \begin{matrix}{θ}_{0} & {θ}_{1} & {θ}_{2} & … & {θ}_{n}\end{matrix} ] [ \begin{matrix}{x}_{o} \\ {x}_{1} \\ {x}_{2} \\ ⋮ \\ {x}_{n}\end{matrix} ] = {θ}^{T} x , \qquad ( 4 )$$

where T is the transpose operation.

In some embodiments, training and testing of one or more machine learning algorithms is performed to generate a plurality of models (as illustrated at 261 of FIG. 2) The metrics x and the acquired data can be used to train one or more machine learning algorithms. In some embodiments, the algorithm trained is a linear support vector machine (SVM) algorithm, capable of separating at least two classes according to the metrics. In some embodiments, the algorithm trained is a logistic regression (LR) algorithm. In some embodiments, the algorithm trained is an artificial neural network algorithm. The algorithm(s) trained may vary depending on practical implementations.

The acquired data or a subset thereof is labelled according to classes to generate labelled data. In some embodiments, labelled data comprises label information corresponding to the performance level of the user. When the data is acquired at step 302, each user's performance level may be recorded, which may be used at step 306 to generate the labelled data. In some embodiments, the labelled data may be generated at step 302. For example, an experienced user (e.g., an experienced surgeon) may have a performance level of “expert” and a less skilled user (e.g., a medical resident) may have a performance level of “non-expert” or “novice”. In some embodiments, one or more people known to be experts may evaluate each user's performance of the task of the simulated scenario 102 and classify the performance level of each user (e.g., “expert” or “non-expert”). It should be appreciated that the labelled data can be used to train the algorithm(s), and once the training platform is generated based on the trained algorithm(s), the people known to be experts may not be needed for classification as the training platform may be used to automatically perform the classification. In some embodiments, the performance level of the user is based on the years of experience of the user. For example, if the user has a number of years of experience over a specific number, the user is classified as an “expert”, otherwise the user is classified as a “non-expert”.

The labelled data may be split into two groups, a training dataset used for training the algorithm and a testing dataset used for testing the algorithm. The training dataset may be used to train the algorithm to recognize the different classes. An iterative cost reduction approach may be employed during training, whereby the algorithm alters values of the weights θ for each one of the metrics x and the bias θ₀ in order to optimize the model to have the greatest predictive accuracy to identify the different classes.

In the training process, a set of input data corresponding to each of the metrics x and the labelled output class (designated as Y_{R}) are supplied to the algorithm. A hypothesis may then be created. The hypothesis h(x) is a function created by the algorithm based on the training dataset. The hypothesis function h(x) assigns weights θ to the input data of each metric x, in order to output a predicted Y. For each iteration, the predicted Y (e.g., “novice”) is compared to the real class Y_{R} (e.g., “expert”), thereby providing insight on the performance of the hypothesis h(x). In some embodiments, the performance of the hypothesis h(x) is determined based on calculating a cost of the hypothesis. The cost of the hypothesis is a function which indicates how incorrect the hypotheses is. If the cost of a hypothesis h(x) is large, the hypothesis h(x) may be able to be improved by modifying its weights θ. One or more optimization methods and/or gradient descent techniques may be used to provide a standardized method to reduce cost. Following some iterations, the cost will reach a minimum, whereby the performance of the hypothesis function h(x) has been optimized.

Once a hypothesis function h(x) has been optimized, it can be set as the generated model at step 306. In some embodiments, the generated model is tested with the testing data set to assess the generalizability of the model and/or to detect overfitting of the model. Overfitting occurs when the model fits the training data too closely and cannot be generalized to new data with similar accuracy. If the generated model is identified as not being accurate, the aforementioned process for generating the hypothesis h(x) may be repeated.

In some embodiments, at step 306, a plurality of models are generated based on the aforementioned algorithm training and testing approach and one of the models is selected as the generated model (as illustrated at 262 of FIG. 2). The selected model may be chosen based on the selected model's accuracy to predict the different classes.

At step 308, competencies are assigned to one or more of the components θᵢxᵢ of the model. Each competency corresponds to an aspect of the simulated scenario 102 having at least two performance levels associated thereto. The competencies may be assigned based on the metrics x and/or the weights θ. In some embodiments, metrics are identified based on a certain skill that a given metric measures, and components having common metrics are grouped into a competency. For example, components having metrics relating to safety may be grouped into a common competency corresponding to safety. By way of another example, components having metrics relating to coordination may be grouped into a common competency corresponding to coordination. Categorizing metrics into groups may be referred to as “chunking”. In some embodiments, the weights are ranked, and weights depending on their values are grouped into a competency. Accordingly, components having weights within a certain range may be grouped into a common competency. For example, components having high weights (e.g., over a threshold value) may be grouped into one competency and components having lower weights (e.g., below a threshold value) may be grouped into another competency. In some embodiments, the assigning of competencies may be based on the level of difficulty of a user to learn a given skill associated with a metric. For example, metrics associated with easier to learn skills can be grouped together and metrics associated with harder to learn skills can be grouped together. The assigning of the competencies may vary depending on practical implementations.

At step 310, the training platform is generated from the model and the simulated scenario 102. The training platform is for training with the simulated scenario 102 and evaluating performance of the simulated scenario 102 by identifying one of the at least two performance levels for at least one of the competencies θᵢxᵢ. The training platform may be generated by assigning the model with the corresponding metrics x and weights θ to the simulated scenario 102 of the simulation system 100, such that a user training with the simulation system 100 is accordingly evaluated.

Referring back to FIG. 2, once the training platform has been generated, the user can use the simulation system 100 to perform one or more actions of the simulated scenario 102 as part of the training platform. At 222, following a similar process to step 302, data is acquired during completion of the simulated scenario 102. At 224, metrics are generated based on the data acquired at 222. In some embodiments, the metrics or the acquired data is normalized to correspond to the training dataset. The normalization method used may comprise calculating the z-score to ensure that all metrics are on the same relative scale. The generated metrics (which may be normalized) are input into the model of the training platform.

In some embodiments, the model can be represented as a logistic sigmoid function:

h(x)=g(θ^{T}x) (5), where z=θ^{T}x (6) and

$$g ( z ) = \frac{1}{1 + {e}^{- z}} . \qquad ( 7 )$$

In some embodiments, the output of the hypothesis function h(x) represents the probability that Y=1 for a given set of metric inputs x with weights θ. The algorithm is now represented by z, and g(z) is analogous to h(x).

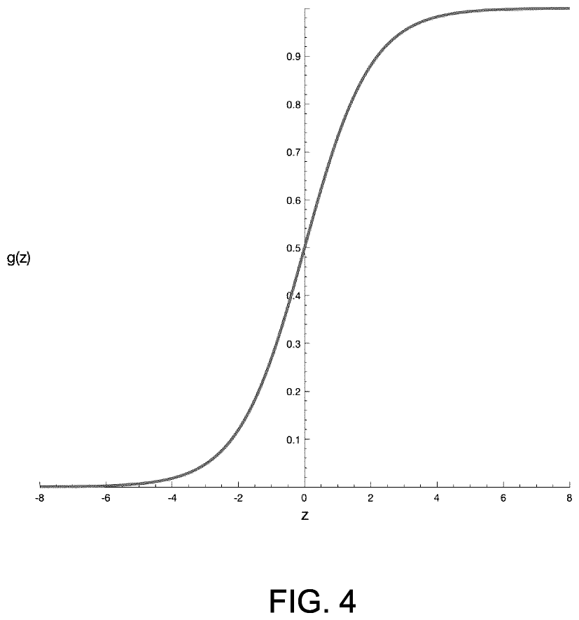

With additional reference to FIG. 4, a plot of the sigmoid function is shown, where the x-axis represents the output of the hypothesis function g(z), and the y-axis is the probability that Y=1. It can be seen in FIG. 4 that when the model yields a positive value for z, the probability that Y=1 is above 0.5. Hence the prediction will be +1. However, if the output of the model is negative, the probability that Y=1 is below 0.5. The prediction would therefore be −1 in this case. This process may be referred to as a discrete value function. it can be noted that as the model yields an increasingly positive value for z, the probability of Y=1 approaches 1. Accordingly, the user will want to attempt to increase the value for z to increase the probability of being correctly classified as an expert.

Individual weights θ have an impact on the model's output. The weights θ may be negative or positive. The larger the absolute value of a weight θᵢ, the larger the influence of its corresponding input xᵢ. For example, in the context of surgical expertise, if the “expert” class is represented by Y=+1 and the “novice” class is represented by Y=−1, a small increase in a metric with a large positive weight will cause a larger shift towards the positive output than one with a small weight. In addition, if a weight is negative, a skilled surgeon is expected to achieve a larger negative metric in order to maximize the positive output.

While the sigmoid function of FIG. 4 is a function that outputs a value between 0 and 1, the output of the sigmoid function may vary depending on practical implementations. For example, the output of the sigmoid function may be between −1 and 1. Accordingly, the user may be classified into one class if the output is between −1 and 0 and into another class if the output is between 0 and 1.

FIG. 4 illustrates one example of a function that may be used to classify the user into one of two performance levels. Other functions may be used to classify the user into three or more performance levels. For example, each performance level may have a function associated therewith. Each function may output a value between 0 and 1. Accordingly, the user may be classified to the performance level corresponding to the function with the highest output valve.

Referring back to FIG. 2, at 226, an overall performance level is determined from the model. That is, the generated metrics of 224 are applied to the model to determine the overall performance level. Accordingly, the user is classified into one of the at least two performance levels (e.g., “expert” or “novice”). Considering the model g(z), if the output of the model g(z) is positive, the user belongs to class Y=+1. In the case of surgical simulation for example, the +1 output could be mapped to the “expert” performance level. However, if the output of the model g(z) is negative, the user would belong to class Y=−1. In a surgical simulation, this output could be mapped to the “non-expert” or “novice” performance level. The determined performance level for the user may be output to a display device, such as display device 108 or a display device separate from the user interface 104.

At 228, each of the components θᵢxᵢ is individually assessed to determine the performance level for each component θᵢxᵢ. Accordingly, the value for each metric xᵢ is multiplied by a corresponding weight θᵢ to determine the value of each component θᵢxᵢ. The value of each component θᵢxᵢ can accordingly be mapped to one to the performance levels to determine the user's performance level for each component θᵢxᵢ. The value of each component θᵢxᵢ may provide insight as to how each metric xᵢ contributes to the model's decision making.

At 230, at least one of the components θᵢxᵢ is provided as feedback to the user. For example, at least one component θᵢxᵢ, or a corresponding performance level, may be output for display. The user may view this output to have a metric-wise assessment of the simulation results. It should be appreciated that a user can be classified as “expert” or “non-expert” as an overall evaluation for the simulation and also provided with an evaluation of each component θᵢxᵢ. For a given component θᵢxᵢ, if the weight θᵢ is positive, the user should aim for a positive metric xᵢ. In some embodiments, the metrics x are normalized through z-score calculation, and accordingly this indicates that the user should aim to achieve a value higher than the mean of the training data to gain a positive normalized metric xᵢ. On the other hand, for a given component, if the weight θᵢ is negative, the user should aim for a negative metric xᵢ. Following the same logic, this corresponds to a value lower than the mean for the training data. The weights θ also provide information on the relative importance of each metric xᵢ on the model's decision-making process. Generally, a larger weight θᵢ corresponds to a larger importance of the metric xᵢ.

It is possible for the output of the model to classify the user as an “expert” while the user is not classified as an “expert” for each component θᵢxᵢ. By way of an example, the model h(x) of equation (1) will now be considered without a bias and with three components:

h(x)=(0·5*1)+(−1·2*0·3)+(1·4*2·1) (8)

In this example, the output h(x) of equation (8) is positive, which corresponds to an expert. However, the user is only considered expert in some, but not all, of the metrics assessed. Expert metrics (positive value for θ*x) therefore overcompensate for non-expert metrics (negative value for θ*x), thereby allowing for an overall positive output. The user is scoring positively in the first and last metric. However, the user scores negatively in the second metric. This indicates that the user may still improve performance for the second metric. Nonetheless, as the sum of the product of each metric and their weight is positive, the user is classified as an expert. This information may be provided to the user and the user may then re-perform the simulated scenario 102 in an attempt to improve his or her performance of the non-expert metric.

It can similarly be appreciated that the model could classify that user as a “novice” overall while the user is classified as an “expert” for at least some of the components.

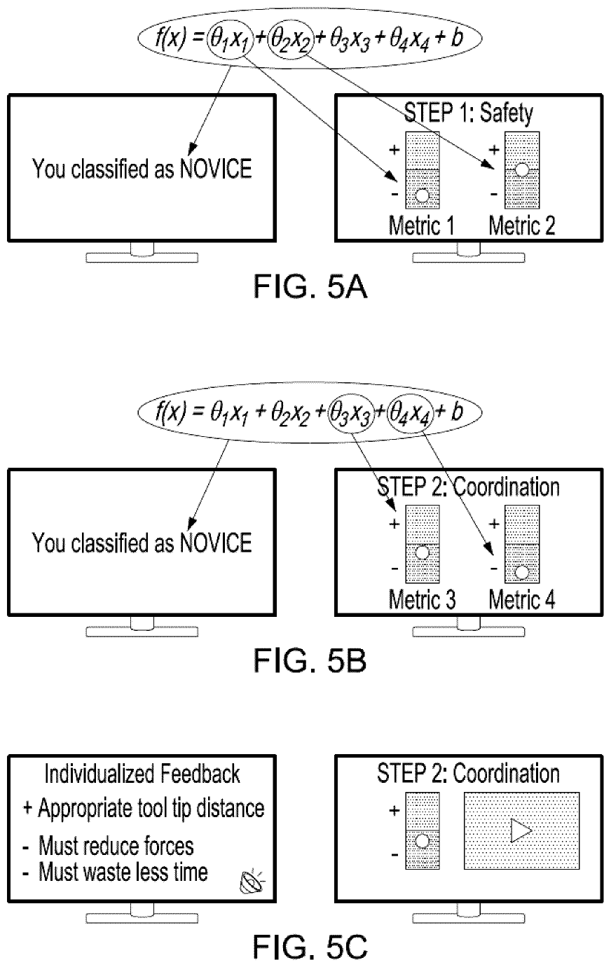

In some embodiments, feedback is provided to the user in a stepwise manner. For example, each assigned competency may be associated with a step of the training platform. The steps may be ordered, in some embodiments, from the competencies that are easier to learn to ones that are more complex. With reference to FIGS. 5A to 5C, a specific and non-limiting example of providing feedback on two display devices is shown. Upon completion of the simulated scenario 102 (and/or during performance thereof), the user receives feedback, divided into two steps, each containing two metrics. In FIG. 5A, the user is provided a performance level classification as computed based on the output of the model. This is accompanied by an individual metric (or component) breakdown for a first step. In this example, the user must achieve a suitable performance level for all metrics (or components) in the first step in order to move on to a second step. In FIG. 5B, once the user achieves the suitable performance level in the first step, this user can access the second step of training. In FIG. 5C, an individualized summary of the user's performance is generated, which may reinforce good behaviour by showing metrics (or components/competencies) where a suitable performance level was achieved and highlighting which metrics (or components/competencies) need to be improved. This may be accompanied by auditory feedback as well as a video for each metric (or component/competency) to illustrate how suitable performance levels may be achieved.

Considering FIGS. 5A to 5C in the context of a virtual reality surgical simulation, the machine learning algorithm computes a performance level classification as “expert” or “non-expert” upon completion of the simulated scenario 102, followed by a step-wise feedback of individual metric (or component/competency) performance. The first step includes metrics related to the competency of safety and the second step, metrics related to the competency of coordination. Each metric is composed of a scale which represents the weight-corrected z-score of the metric. Negative values indicate a non-expert performance for the respective metric, whereas positive values indicate an expert performance for the respective metric. In some embodiments, the training platform is iterative, whereby the user must achieve a suitable performance level in all metrics of the first step, in order to move on to the second step. In some embodiments, if the user fails to do so, this individual must repeat the task of the simulated scenario 102 corresponding with this metric until the suitable performance level is achieved.

Referring back to FIG. 2, at 232, a summary of the user's performance may be provided at each iteration. This may reinforce the user's positive behaviours where competency was achieved, while also addressing the metrics where the user performed poorly. Furthermore, the summary may incorporate automated auditory and/or video-based instructions, for example, to address psychomotor metric issues identified. This feature may be designed to mimic current surgeon instructor feedback strategies in the operating room while allowing for self-guided learning. The text feedback may provide a breakdown of positive behaviours and behaviours to improve. The auditory components may provide more holistic feedback imitating what the user would receive from the surgeon instructor in the operating room. As individual psychomotor metrics may be difficult to teach, a video for each metric to illustrate how a skilled surgeon would perform the respective metric may be provided. Accordingly, the training platform may facilitate the transition of the user from one performance level (e.g., novice) to another performance level (e.g., expert).

While the simulation system 100 and the training platform are described herein by way of examples in the context of a surgical simulation, this is only one example of use of the system 100 and the training platform. It should be appreciated that the simulation system 100 and the training platform may be used for any suitable simulation. For example, the simulation system 100 and the training platform may be used in areas such as aviation, machinery, army, etc. By way of another example, the simulation system 100 and the training platform may be applied to a driving simulator where a large dataset is generated, broken down into metrics used to train a machine learning classifier to differentiate between an expert driver and novice driver, and finally compiled into an education platform to assist in the transition of a new driver from novice to expert classification.

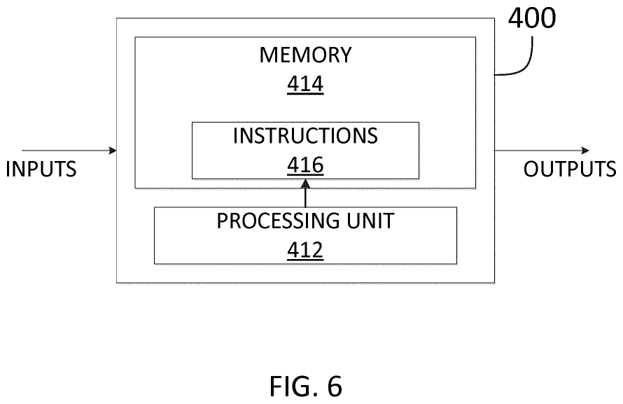

With reference to FIG. 6, the framework of FIG. 2 and/or the method 300 may be implemented by a computing device 400, comprising a processing unit 412 and a memory 414 which has stored therein computer-executable instructions 416. The processing unit 412 may comprise any suitable devices configured to implement the system such that instructions 416, when executed by the computing device 400 or other programmable apparatus, may cause the functions/acts/steps of the method 300 as described herein to be executed. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 416 executable by processing unit 412.

The methods and systems for generating and/or using a training platform described herein may be implemented in a high level procedural or object oriented programming or scripting language, or a combination thereof, to communicate with or assist in the operation of a computer system, for example the computing device 400. Alternatively, the methods and systems for generating and/or using a training platform may be implemented in assembly or machine language. The language may be a compiled or interpreted language. Program code for implementing the methods and systems for generating and/or using a training platform may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for generating and/or using a training platform may also be considered to be implemented by way of a non-transitory computer-readable storage medium having a computer program stored thereon. The computer program may comprise computer-readable instructions which cause a computer, or in some embodiments the processing unit 412 of the computing device 400, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for generating and/or using a training platform may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method for generating a training platform, the method comprising:
acquiring data indicative of users interacting with a simulated scenario;
generating, from the acquired data, a plurality of metrics for evaluating performance of tasks within the simulated scenario;
generating a model based on the acquired data and the plurality of metrics, the model corresponding to a sum of components comprising the plurality of metrics and associated weights;
assigning competencies to one or more of the components of the model, the competencies corresponding to aspects of the simulated scenario having at least two performance levels associated thereto; and
generating, from the model and the simulated scenario, the training platform for evaluating performance by selecting one of the at least two performance levels for the competencies.

2. The method of claim 1, further comprising selecting a subset of metrics from the plurality of metrics based on an ability to differentiate between two or more classes, and wherein generating the model comprises generating the model based on the subset of metrics.

3. The method of claim 1, wherein the model is represented by:
h(x)=θ₀+θ₁x₁+θ₂x₂+ . . . +θₙx
where h(x) corresponds to a hypothesis, θᵢ corresponds to an i-th weight associated with an i-th metric xᵢ, θᵢxᵢ corresponds to an i-th component, and where θ₀ corresponds to a bias assignable to zero.

4. The method of claim 1, wherein components are grouped into common competencies based on parameters associated with at least one of the metrics and the weights.

5. The method of claim 1, wherein the training platform outputs an overall performance level based on the sum of the components and at least one competency-related performance level based on at least one of the components.

6. The method of claim 5, wherein the competency-related performance level is displayed to show performance levels of individual metrics associated with a corresponding competency.

7. The method of claim 1, wherein the training platform tests the competencies in a multi-step scenario, wherein a given step is presented when a predetermined performance level is achieved on a previous step.

8. The method of claim 1, wherein the acquired data comprises measurements associated with a control device operated by a user while performing tasks within the simulated scenario.

9. The method of claim 8, wherein the measurements comprise at least one of positional measurements, rotational measurements, and force measurements associated with the control device.

10. The method of claim 8, wherein the control device is a surgical tool and the simulated scenario is a surgical task.

11. A system for generating a training platform, the system comprising:
at least one processing unit; and
a non-transitory computer-readable memory having stored thereon program instructions executable by the at least one processing unit for:
acquiring data indicative of users interacting with a simulated scenario;
generating, from the acquired data, a plurality of metrics for evaluating performance of tasks within the simulated scenario;
generating a model based on the acquired data and the plurality of metrics, the model corresponding to a sum of components comprising the plurality of metrics and associated weights;
assigning competencies to one or more of the components of the model, the competencies corresponding to aspects of the simulated scenario having at least two performance levels associated thereto; and
generating, from the model and the simulated scenario, the training platform for evaluating performance by selecting one of the at least two performance levels for the competencies.

12. The system of claim 11, wherein the program instructions are further executable for selecting a subset of metrics from the plurality of metrics based on an ability to differentiate between two or more classes, and wherein generating the model comprises generating the model based on the subset of metrics.

13. The system of claim 11, wherein the model is represented by:
h(x)=θ₀+θ₁x₁+θ₂x₂+ . . . +θₙxₙ
where h(x) corresponds to a hypothesis, θᵢ corresponds to an i-th weight associated with an i-th metric xᵢ, θᵢxᵢ corresponds to an i-th component, and where θ₀ corresponds to a bias assignable to zero.

14. The system of claim 11, wherein components are grouped into common competencies based on parameters associated with at least one of the metrics and the weights.

15. The system of claim 11, wherein the training platform outputs an overall performance level based on the sum of the components and at least one competency-related performance level based on at least one of the components.

16. The system of claim 15, wherein the competency-related performance level is displayed to show performance levels of individual metrics associated with a corresponding competency.

17. The system of claim 11, wherein the training platform tests the competencies in a multi-step scenario, wherein a given step is presented when a predetermined performance level is achieved on a previous step.

18. The system of claim 11, wherein the acquired data comprises measurements associated with a control device operated by a user while performing tasks within the simulated scenario.

19. The system of claim 18, wherein the measurements comprise at least one of positional measurements, rotational measurements, and force measurements associated with the control device.

20. The system of claim 18, wherein the control device is a surgical tool and the simulated scenario is a surgical task.
